(19) United States
(12) Patent Application Publication
(10) Pub. No.: US 2016/0339280 A1
(43) Pub. Date: Nov. 24, 2016

(54) Fire Extinguishing Pod

(71) Applicant: STRATEGIC FIRE CONTROL PTY LTD, Dalkeith, Western Australia (AU)

(72) Inventor: Chad Sexton-Finck, Dalkeith, Western Australia (AU)

(21) Appl. No.: 15/112,878

(22) PCT Filed: Jan. 20, 2015
(86) PCT No.: PCT/AU2015/000027

§ 371 Date: Jul. 20, 2016

(30) Foreign Application Priority Data
Jan. 20, 2014 (AU) 2014900155

(51) Int. Cl. A62C 3/02

(52) U.S. Cl. CPC A62C 3/025

(57) ABSTRACT

The present invention provides a fire extinguishing pod (11) for use in fighting a target area of a fire. The pod comprises a housing (15) for housing a fire retardant (16). The housing comprises a thin-walled outer casing (17) and a light weight container (19) which receives and contains the fire retardant. Upon detonation of the container the housing disintegrates into small pieces and the fire retardant is released from the pod. After detonation the pieces are of a size which will not cause injury should the pieces fall on property or persons.

### TECHNICAL FIELD

The present invention generally relates to a fire extinguishing pod. In particular the present invention relates to a fire extinguishing pod which can deliver a quantity of fire retarding material to a fire.

### BACKGROUND ART

Fires can have devastating effects on property and lives. It is therefore important that communities are provided with firefighting capabilities to ensure fires are controlled and extinguished as quickly as possible.

Some of the more difficult fires to fight are those which occur as large outbreaks (e.g. bush land), in inaccessible locations, high rise building, ships and aircraft at airports.

Large outbreaks of fire commonly occur in Australia, US and Europe. In these situations it is common to use aircraft to drop fire extinguishing/retarding substances onto the fire. This has proven to be a very costly and time consuming method and is largely inefficient due to the limited effect this method has in timely dealing with difficult outbreaks.

It has been found that the likelihood of controlling a fire is greatly increased if the first attack on that fire occurs within half an hour of ignition. It is therefore critical in those areas susceptible to large outbreaks that aerial firefighting facilities are available and can quickly respond to the first sign of a fire.

While aircraft can be effective, the associated cost to have these aircraft available is significant, even when on standby. An alternative solution is the use of projectiles to deliver a quantity of fire extinguishing/retarding substances to the fire. Unfortunately the projectiles are generally limited in their application as they are generally unsafe to use or cannot be suitably controlled.

Fires which require attention generally occur in populated areas (albeit sometimes sparsely). It is therefore critical that any projectile will not cause any damage or injury should it fail and fall to the ground. Furthermore it is essential that should it not reach its target destination that it doesn't create any new fires. Examples of fire-fighting projectiles can be found in U.S. Pat. No. 7,121,353 to Setzer and US 20090250229 to Willner.

US 20090250229 provides a missile which delivers a fire retardant to a fire. The fire retardant is contained in a pressurized reservoir and is dispersed upon opening of a valve. The release of the fire retardant from the missile relies upon the melting of a nose cone which then exposes operational components of the reservoir. As the operation of the missile is dependent on the melting of the nose cone the missile must be accurately positioned/guided to ensure the nose cone has melted by the time the missile reaches its target area. Furthermore, once the missile completes its task it falls to the ground which can lead to further damage of property or injury to people in the vicinity.

U.S. Pat. No. 7,121,353 provides an airborne vehicle equipped with a container. The container comprises a metal grating which supports a bag which contains an extinguishant. Upon detonation the bag bursts and a mist is delivered through the grating to the fire. While a mist has been effective in managing a fire, U.S. Pat. No. 7,121,353 cannot deliver a large quantity of liquid to the fire to saturate the area on fire. Furthermore, once the airborne vehicle completes its task it falls to the ground which can lead to further damage of property or injury to people in the vicinity.

The preceding discussion of the background art is intended to facilitate an understanding of the present invention only. The discussion is not an acknowledgement or admission that any of the material referred to is or was part of the common general knowledge as at the priority date of the application.

### SUMMARY OF INVENTION

It is an object of this invention to provide fire extinguishing pod which ameliorates, mitigates or overcomes, at least one disadvantage of the prior art, or which will at least provide the public with a practical choice.

The fire extinguishing pod is adapted to deliver a fire retardant to a fire. The fire retardant may be in the form of any substance which can retard or extinguish fire, and can take any form. For instance, the fire retardant may be in the form of foam, liquid, or powder.

The present invention further provides a fire extinguishing pod for use in fighting fires, the pod comprises:
a housing for housing a fire retardant, the housing comprising
   a thin-walled outer casing, and
   a light weight container which receives and contains the fire retardant,
whereupon detonation of the container the fire retardant is released from the pod

The present invention provides a fire extinguishing pod for use in fighting fires, the pod comprises:
a housing for housing a fire retardant, the housing comprising
   a thin-walled outer casing, the thin walled outer casing incorporating an opening system which is movable from a closed position to an open position, and
   a light weight container which receives and contains the fire retardant,
whereupon the opening system moving to the open position, the container is pierced allowing the fire retardant to be released from the pod.

The opening system may comprise a plurality of louvres/vents incorporated in the casing.

The opening system may be controlled to open the louvres/vents to the open position or to a partially opened positioned. The louvres/vents may be influenced by the movement of the pod through the air. As the velocity of the pod reduces the vents/louvres have less force acting thereupon and may move fully to the open position, allowing more fire retardant to be ejected from the pod.

The present invention further provides a fire extinguishing pod for use in fighting a target area of a fire, the pod comprises:
a housing for housing a fire retardant, the housing comprising
   a thin-walled outer casing, and
   a light weight container which receives and contains the fire retardant,
whereupon detonation of the container the housing disintegrates into small pieces and the fire retardant is released from the pod, the pieces being of a size which will not cause injury should the pieces fall on property or persons.

The present invention further provides a fire extinguishing pod for use in fighting fires, the pod being adapted to travel through atmosphere to a target area, the pod comprises:
a housing for housing a fire retardant, the housing comprising
   a thin-walled outer casing, and
   a light weight container which receives and contains the fire retardant,
whereupon detonation of the container the fire retardant is released from the pod

The present invention further provides a fire extinguishing pod for use in fighting fires, the pod comprises:
a housing for housing a fire retardant, the housing comprising
   a thin-walled outer casing, and
   a light weight container which receives and contains the fire retardant, the light weight container
wherein the pod incorporates two modes of operation, a saturation mode whereby the fire retardant is rapidly discharged from the pod to a discrete target area and a spreading mode whereby the fire retardant is gradually discharged from the pod as the pod travels over a larger target area.

In the saturation mode the container may be detonated to allow for the rapid discharge of the fire retardant from the pod.

In the spreading mode the container may be pierced to allow for the gradual discharge of the fire retardant from the pod.

The pod may be capable of one or both modes of operation.

When the pod reaches the target area the pod may commence operation in the spreading mode whereby the pod attacks a fire in the spreading mode of operation, and then changes to a saturation mode under certain conditions. Those conditions which trigger the change in mode may relate to the volume of fire retardant in the container reaching a predetermined level, the pod reaching a part of the fire having a certain temperature, or loss of control of the pod. Other conditions which are obvious to a person skilled in the art are also incorporated herein.

Preferably the outer casing incorporates an opening system which is movable from a closed position to an open position, wherein in the closed position the outer surface of the casing is relatively smooth, wherein in the open position the casing provides at least one aperture therein.

Preferably when the opening system moves to the open position, the container is pierced allowing the fire retardant to be released from the pod through the at least one aperture.

The opening system may comprise a plurality of louvres/vents incorporated in the casing. The plurality of louvres/vents may each be associated with an opening in the casing.

The opening system may be controlled to open the louvres/vents to the open position or to a partially opened positioned. The louvres/vents may be influenced by the movement of the pod through the atmosphere. As the velocity of the pod reduces, the vents/louvres have less force acting thereupon and may move fully to the open position, allowing more fire retardant to be ejected from the pod.

Preferably the housing disintegrates into small pieces and the fire retardant is released from the pod upon detonation of the container. Preferably the pieces are of a size which will not cause damage or injury should the pieces fall on property or persons.

In one aspect of the invention the pod has a first propulsion apparatus for propelling the pod to the target area. The first propulsion apparatus may be releasably secured to the housing. The first propulsion apparatus may be released from the housing prior to the pod reaching the fire. Upon release The first propulsion apparatus may deploy a parachute and fall to the ground. The first propulsion apparatus may be collected and re-used with a new housing. The first propulsion apparatus may incorporate a tracking system to allow an operator to readily locate the first propulsion apparatus.

Preferably the first propulsion apparatus has large throttling capabilities through the broad range of thrust throttling to facilitate the on demand impulse management required.

The first propulsion apparatus may be in the form of a hybrid rocket. There are inherent safety attributes to hybrid rocket motors since the liquid oxidiser and fuel are separated. Furthermore, as the pod will only travel short distances fuel and oxidiser quantities only need to be very small. Hybrid rocket motors can be cleaned relatively easily therefore adding to the ability of the rocket to be reused.

The hybrid rocket may comprise a solid fuel such as paraffin based fuel, and a gas such as oxygen. Paraffin-based fuels are non-toxic, nonhazardous and are relatively easy to transport when compared to other types of fuels. Furthermore, this type of hybrid rocket produces zero dangerous chemicals as the reaction of paraffin and oxygen produce carbon dioxide and water

The first propulsion apparatus may be operated during flight such that it can be turned on or off repeatedly. Hence if the pod is going off course an operator can readily turn the first propulsion apparatus off. Also, an operator can control the distance the pod travels by turning the first propulsion apparatus on and off as it travels to the target area.

The first propulsion apparatus may be switched off before it detaches from the housing. This ensures that the first propulsion apparatus does not continue to travel, as well as ensuring the first propulsion apparatus does not ignite new fires upon reaching the ground.

In another aspect of the invention the pod relies on an external propulsion system. In this regard the external propulsion system may take the form of an aircraft, or a land based launch system.

The container is made from a lightweight non-metallic material. The material may be micro-lattice or aerographite. Micro-lattice and aerographite are currently one of the strongest, lightest materials known. Both materials are able to provide the container with the requisite strength to contain the fire retardant while adding very little to the overall weight of the pod.

In one aspect of the invention the container incorporates explosive charges therein such that upon detonation the resultant explosion causes the container to disintegrate into small pieces which are sufficiently small to fall harmlessly to the ground.

The casing may also incorporate explosive charges therein such that upon detonation the resultant explosion causes the casing to disintegrate into small pieces which are sufficiently small to fall harmlessly to the ground.

Preferably the container and casing explode simultaneously such that the housing disintegrates into small pieces.

In another aspect of the invention the container incorporates explosive charges therein such that upon detonation the resultant explosion causes the housing to disintegrate into small pieces which are sufficiently small to fall harmlessly to the ground.

Preferably the container is reinforced by a series of straps which surround the container in a grid like pattern.

In one aspect of the invention the straps may be made from the same lightweight material from which the container is made. The straps may incorporate an explosive material.

In another aspect of the invention the straps may be made from an explosive material.

The straps may be configured such that upon detonation the resultant explosion causes the container to disintegrate into small pieces which are sufficiently small to fall harmlessly to the ground.

The straps may be configured such that upon detonation the resultant explosion causes the housing to disintegrate into small pieces which are sufficiently small to fall harmlessly to the ground.

The pod may incorporate a guidance system to guide the pod to a target area. The guidance system may rely upon at least one or a combination of the below:
radar to guide the pod to the target area;
heat sensor to guide the pod to part of a fire having a specific temperature;
GPS to guide the pod to a geographical location;
Gyroscope to guide the pod based on its angular orientation;
Altimeter to guide the pod based on its height.

The first propulsion apparatus may be operated remotely and/or may be operably dependent on the guidance system.

The guidance system may incorporate a camera which transmits video to the operator. This will allow an operator to position the delivery of the pod which is critical in relation to relatively small fires such as those in high rise buildings.

The pod may comprise a steering system which can steer the pod to the target area. The steering system may be operated remotely and/or may be operably dependent on the guidance system.

The pod may comprise gliding apparatus to increase the distance the pod may travel. The gliding apparatus may include fins. The fins may be extendible from a retractable position to an extended position. The fins may add stability to the pod during flight.

The pod may comprise a second propulsion apparatus, wherein the second propulsion apparatus propels the pod in a substantially vertical direction. The second propulsion apparatus may enable the pod to hover before the first propulsion apparatus is activated to propel the pod forward. This is advantageous when the pod is used to fight a fire in a high rise building.

The first propulsion apparatus may be operated remotely and/or may be operably dependent on the guidance system.

The detonation of the pod may be remotely activated by an operator, or may be automatically activated according to the condition of the pod. In this regard the automatic activation may rely upon at least one or a combination of the below:
heat sensor to activate detonation upon sensing a set temperature;
impact sensor to activate detonation upon impact;
load sensor to activate detonation upon the weight of the housing dropping below a predetermined value;
GPS to activate detonation upon reaching a geographical location, or upon moving outside a geographical region;
altimeter to activate detonation at a certain height.

The pod may be shut down and the parachute deployed if the pod strays beyond its intended course of travel. This is advantageous when the pod presents no danger to property or people. If the pod strays beyond its intended journey and cannot be retrieved by other means, the propulsion apparatus can be shut down and the parachute deployed allowing the pod to return safely to the ground. It can then later be collected and reused.

The present invention provides a quick, efficient and safe response to dangerous situations to life and property, as well as being an effective method of preserving the environment, fauna and flora from lengthy infernos. This is achieved without compromising the safety of people or property in that area.

An embodiment of the present invention is a firefighting system which uses existing hybrid rockets to combat large fires which are out of control and/or which are inaccessible due to terrain, heat, proximity or height.

Furthermore, this invention provides an effective solution to situations which render traditional firefighting practices as totally inadequate, as in the case of fires in high rise buildings, on large shipping and in airport fires.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a fire extinguishing pod according to a first embodiment of the invention illustrating the staged recovery of a first propulsion apparatus of the pod;

FIG. 2 is a schematic view of a container used in the pod of FIG. 1;

FIG. 3 is a cross sectional view of the container shown in FIG. 2;

FIG. 4 is a schematic view of the container in FIG. 2 showing a series of reinforcement straps;

FIG. 5 is a schematic view of a housing in FIG. 1 showing disintegration of the container upon detonation;

FIG. 6 is a schematic view of the housing in FIG. 5 showing operation of an opening system of the pod;

FIG. 7 illustrates the launch of the fire extinguishing pod of FIG. 1 and its cycle; and

FIG. 8 is a fire extinguishing pod according to a second embodiment of the invention.

In the drawings like structures are referred to by like numerals throughout the several views. The drawings shown are not necessarily to scale, with emphasis instead generally being placed upon illustrating the principles of the present invention.

### DESCRIPTION OF EMBODIMENTS

The present invention provides fire fighters with a quick response firefighting system which will allow them to rapidly commence fighting a fire from a safe location. It also allows fires in inaccessible locations to be fought, and enables a fire fighter to accurately attack a fire.

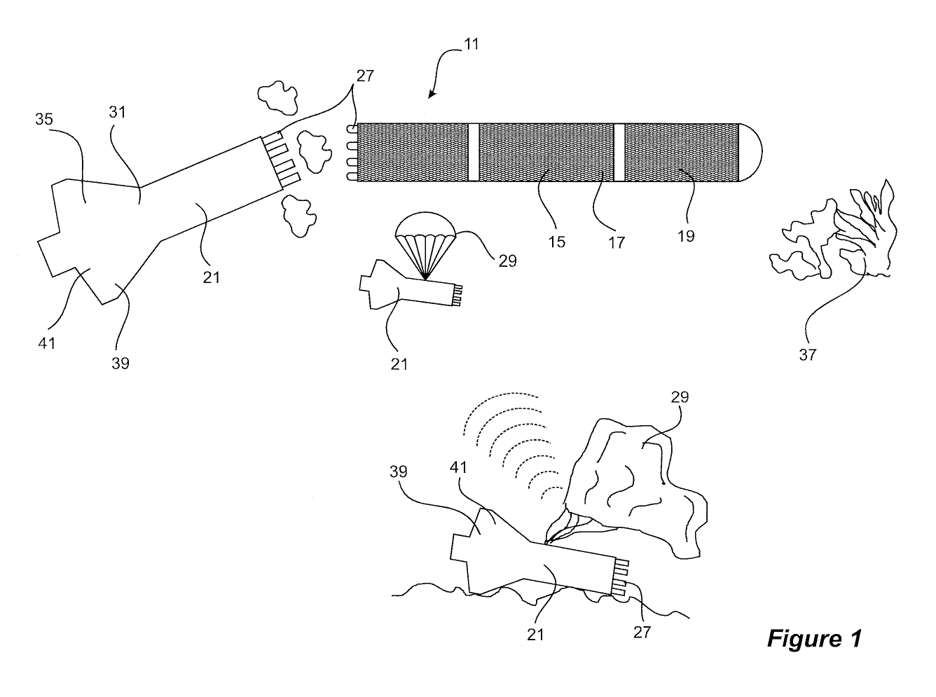

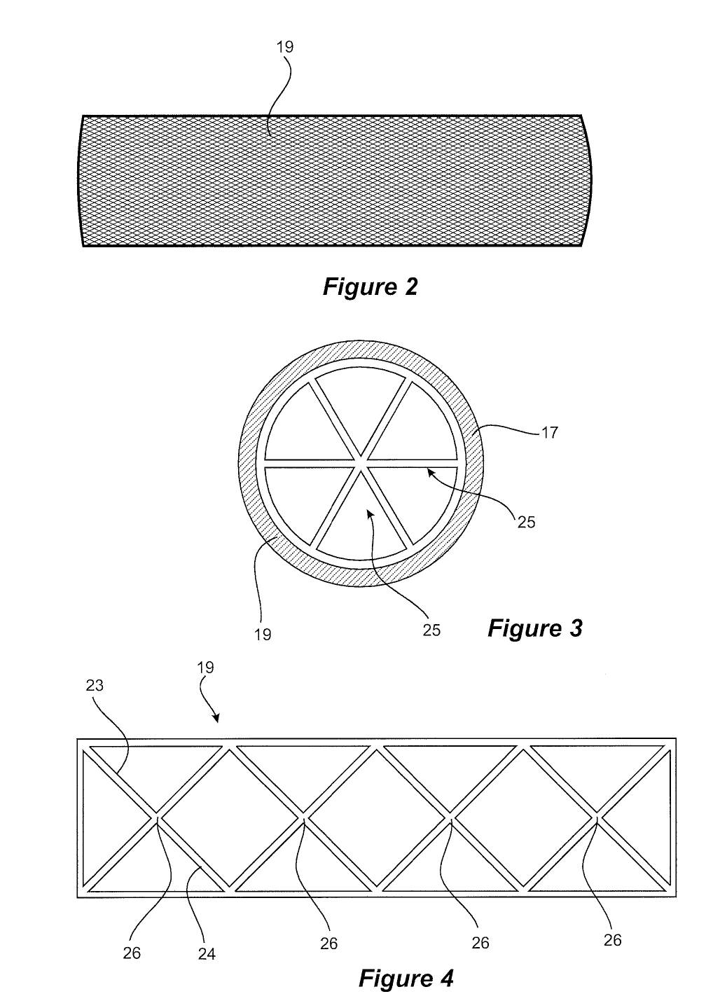

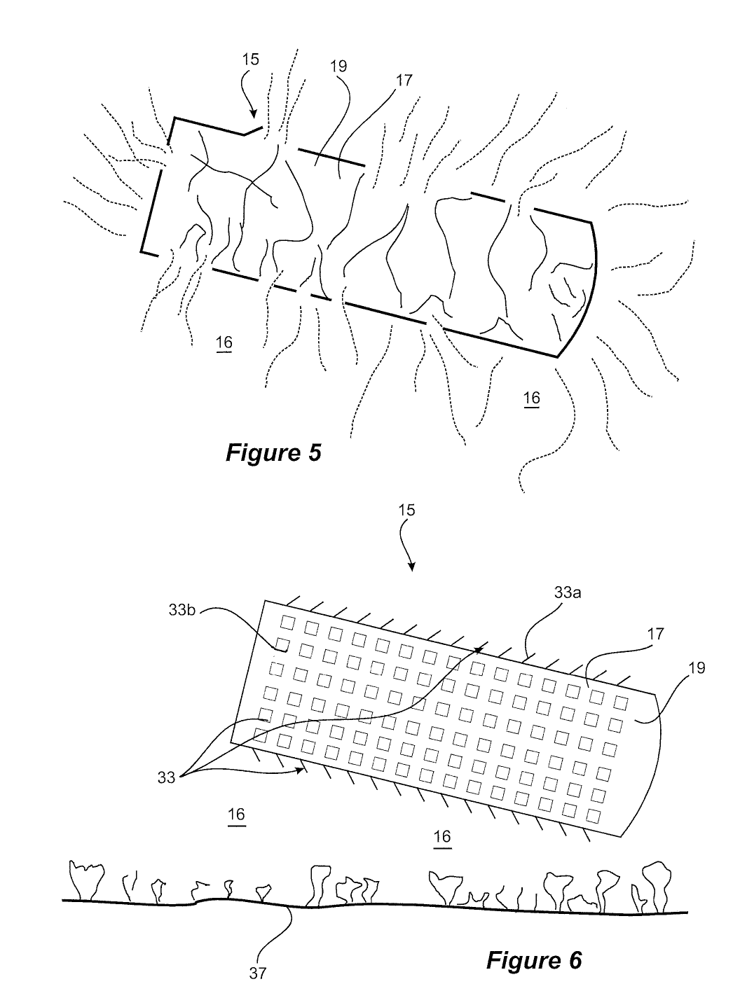

Referring to FIGS. 1 to 7, the invention according to the first embodiment is in the form of a fire extinguishing pod 11. The pod 11 is adapted to travel through the atmosphere from a launch location to a target area, generally a fire or a part of a fire. The pod 11 may be launched from air, such as from an aircraft, from water, or from a land based launcher. The land based launch may be in the form of a mobile vehicle or trailer, or from a fixed base. Owing to the lightweight construction of the pod 11, and the materials used, the pod 11 is highly mobile and safe to store.

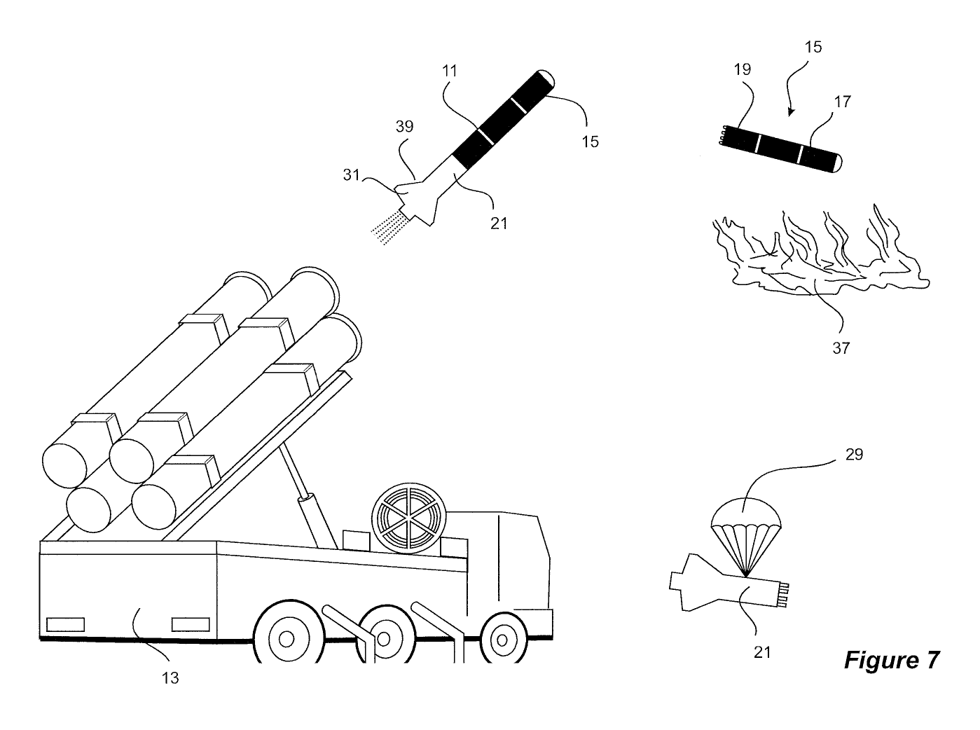

In the present embodiment, a plurality of the pods 11 are shown as being stored, transported and launched from a truck 13, as shown in FIG. 7. In this embodiment the pod 11 has its own power but in other embodiments the pod 11 may glide or be catapulted to the target area.

The pod 11 comprises a housing 15 releasable secured to a first propulsion apparatus 21.

The housing 15 comprises a thin walled outer casing 17 and a container 19 encased by the casing 17. The container 19 is made from a lightweight material which, in this embodiment, is aerographite.

The container 19 contains fire retardant 16, which in this embodiment is water. The container 19 is reinforced by a series of straps 23 which surround the container in a grid like pattern, as best shown in FIG. 4. The straps 23 are made from aerographite and contain an explosive material 24 for reasons which will be described below.

The container 19 also comprises a plurality of explosive charges 26 strategically positioned to ensure disintegration of the housing 15 into small pieces. As aerographite is electrically conductive, it may be used to assist in the detonation of the container 19.

The container 19 also comprises an internal support frame 25 to add support to the container. The need to include the internal support frame 25 is dependent on the size of the pod 11 and the thickness of the housing 15. It is to be readily understood by the person skilled in the art that the internal support frame 25 will not be required in all applications.

The casing 17 incorporates an opening system in the form of a plurality of louvres/vents 33, as best shown in FIG. 6. The louvres 33a are movable from a closed position, whereby they cover apertures which are in the form of vents 33b to an open position, as best shown in FIG. 6. In the open position vents 33b are open.

In the closed position the louvres 33a align with the outer surface of the casing presenting a smooth outer surface. As the louvres 33a move to the open position the container is pierced by the action of the louvres 33b allowing the fire retardant in the container 19 to flow from the housing 15.

In this embodiment the extent to which the louvres/vents 33 are open is dependent on the volume of the container 19 and the velocity of the housing 15.

In this embodiment the opening system is activated by an operator.

The first propulsion apparatus 21 provides the necessary propulsion to propel the housing 15 to the target area 37. At some point during the journey the housing 15 will have sufficient momentum for it to continue to the target area without further propulsion. When the housing 15 reaches this point the first propulsion apparatus 21 detaches from the housing 15. In this embodiment this is achieved using a locking arrangement 27 which undergoes a small explosion to release the first propulsion apparatus 21 from the housing 15.

The first propulsion apparatus 21 is in the form of a hybrid rocket 31 and incorporates a parachute 29 which is deployed upon release of the first propulsion apparatus 21 from the housing 15. The parachute 29 enables the first propulsion apparatus 21 to return gently to the ground.

The first propulsion apparatus 21 also incorporates a location device to allow an operator to easily locate the first propulsion apparatus 21. The first propulsion apparatus 21 can then be refuelled, connected to a new housing and re-used.

The pod 11 is capable of operating in two modes, a spreading mode and a saturation mode.

In the spreading mode the louvres/vents 33 are activated to allow fire retardant in the container 19 to discharge gradually from the housing 15. If the louvres/vents 33 are activated during flight then the movement of the housing 15 will spread the fire retardant over a greater area.

In the saturation mode the container 19 is detonated when the housing 15 reaches the target area. Upon detonation the housing disintegrates into small pieces and the fire retardant is immediately dumped from the housing. The dumping of the fire retardant saturates the area.

Owing to the configuration of the explosives 24, 26, detonation of the container 19 will result in the entire housing 15 disintegrating into small pieces. These pieces are sufficiently small such that they cannot cause any damage when they fall to the ground. In other embodiments the entire housing may incorporate an explosive material.

The first propulsion apparatus 21 contains a guidance system 35 to guide the pod 11 to the target area 37. In other embodiments the guidance system 35 may be located in the housing 15 or a combination of the housing 15 and the first propulsion apparatus 21.

The pod 11 incorporates a series of fins 39 around a base 41 of the first propulsion apparatus 21 to enhance the flight of the pod 11 once launched.

Upon detection of a fire, the truck 13 can be readily positioned a safe distance from the target area 37. The target area 37 is decided by the operator/fire fighters and may be the ignition point of the fire, the hottest part of the fire, or a series of locations which multiple pods 11 may be guided.

Once the truck 13 is in position, the operator can activate one or more of the pods 11. If the pods 11 do not have onboard guidance systems the truck may be aligned with the target area 37. Once launched an operator can regulate the hybrid rocket 31 to guide the pod 11 to the target area 37.

During the flight the locking arrangement 27 can be activated to release the first propulsion apparatus 23 from the housing.

Upon release, the parachute 29 is deployed allowing the first propulsion apparatus 21 to return to earth.

After it is released the housing 15 continues towards the target area 37. As the housing 15 approaches the target area 37 the operator can cause the pod 11 to enter the spreading mode of operation or the saturation mode to fight the fire.

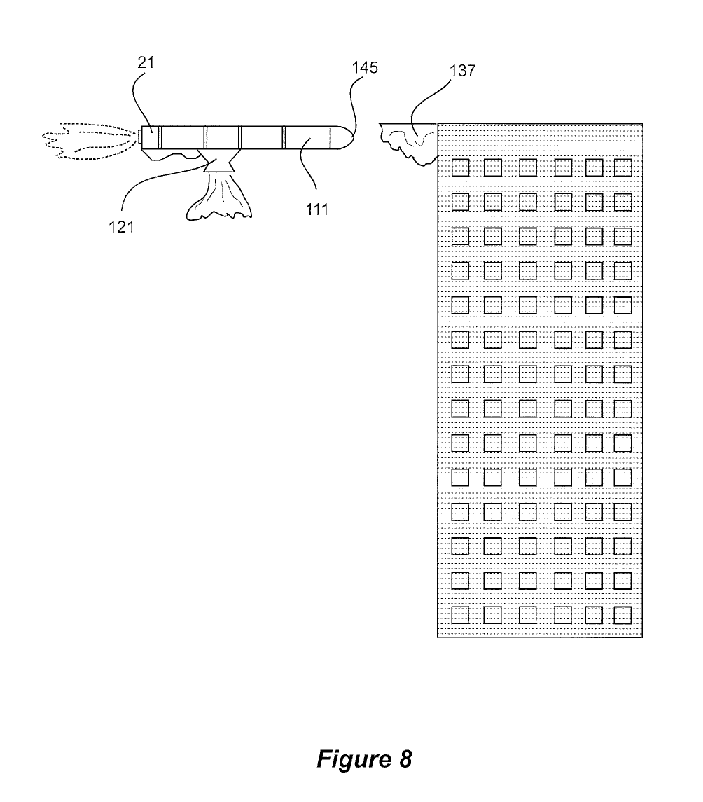

The invention according to a second embodiment is in the form of a fire extinguishing pod 111 and is illustrated in FIG. 8. For convenience features of the pod 111 that are similar or correspond to features of the pod 11 of the first embodiment have been referenced with the same reference numerals.

In the second embodiment the pod 111 is identical in construction as the pod 11 but has a second propulsion apparatus 121 which is orientated to move the pod 111 in a vertical direction. The second propulsion apparatus 121 incorporates a hybrid rocket.

The pod 111 also comprises a camera 145 which transmits an image to a monitor (not shown) operated by an operator.

This particular embodiment is well suited for fighting fires in a building 137. When a fire occurs in the upper region of a high rise building 137 it is often difficult for firefighters to readily access the fire. The pod 111 allows the fire fighters to quickly and accurately attack a high rise fire.

When a high rise building 137 is on fire, one or more pods 111 may be located nearby. An operator can initiate the second propulsion means 121 of the pod 111 causing the pod 111 to rise vertically. By using the camera 145 in the pod 111 the operator is able to regulate the power of the second propulsion apparatus 121 until the camera 145 indicates the pod 111 is correctly aligned with the floor which is on fire. The operator can then activate the first propulsion means 21 causing forward movement of the pod 111 into the building 137.

Once in the building the operator may detonate the container 19 to dump the fire retardant on the fire.

Firefighting is about:
getting to the location quickly and working safely (task enabling),
getting to the task quickly (reduced transit times),
getting a large mass of water there (increased payload mass) and
getting the ‘out of control’ areas under control to minimize damage in the most cost effective manner.
   The fire extinguishing pods of the present invention provide means which allow effective firefighting capabilities, without compromising the safety of property and people.

The fire extinguishing pods are not overly complex and are made from relatively inexpensive material, and/or may be re-used. For instance, hybrid rockets, which may be used to provide the propulsion apparatus, are very robust and powerful. Liquid oxygen, paraffin-fuelled hybrid rockets, 28 centimeters in diameter can produce 25,000 newtons of thrust. A 56 cm diameter hybrid rocket is capable of 100,000 newtons of thrust which is enough to lift more than 10 metric tons.

The fire extinguishing pods can vary in size according to the nature of the contents and their intended purpose. It is expected that most fire extinguishing pods will range from approximately 2.5 to 5 meters in length and 0.5 to 0.8 meters in diameter and will be particularly useful in delivering fire retardants over short distances (100-4000 meters) at low altitudes. However, it is to be understood that the fire extinguishing pods can be designed to be of any size and can travel greater distances.

The containers 19 can be built in sections and the casing 17 may be light metal alloy skins to present a very strong but disintegrable housing 15 on detonation.

When flight distances are relatively short, the required trajectories are safe and the altitudes low for the launchers. Also as the housings are built of the lightest tensile materials, the fuelling systems and launcher engines are correspondingly small, reducing costs and mishaps considerably.

The truck 13 does not require sophisticated launching systems as the distances and altitudes are generally anticipated to be small/low and therefore do not require large launcher engines or solid fuel systems.

It is generally expected that most applications of the fire extinguishing pods will have short propulsion launcher times to deliver large payloads of fire retardants to difficult terrains, heat proximities or dangerous situations.

Multiple pod carrying trucks could be housed in selected stations or saturation depots and could be at the ready in large numbers.

The present invention enables communities to:
have a rapid response firefighting system;
have firefighting capabilities without the expense associated with aerial fire fighters (or at least reduce these costs);
fight fires without saturation supply depots on hand;
reach almost anywhere and complete a host of firefighting objectives at the destination with greater reliability, speed and safety;
decrease transit times to source of fire;
increase the amount, and accurately deploy fire retardant;
safe delivery to dangerous fire centers at decreased costs, while minimising the exposure of firefighters to dangerous conditions.

Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein.

Reference to positional descriptions, such as lower and upper, are to be taken in context of the embodiments depicted in the figures, and are not to be taken as limiting the invention to the literal interpretation of the term but rather as would be understood by the skilled addressee.

Throughout this specification, unless the context requires otherwise, the word “comprise” or variations such as “comprises” or “comprising”, will be understood to imply the inclusion of a stated integer or group of integers but not the exclusion of any other integer or group of integers.

While the invention has been shown and described with reference to certain exemplary embodiments thereof, it will be understood by those skilled in the art that various changes in form and details may be made therein without departing from the spirit and scope of the invention as defined by the appended claims.

1. A fire extinguishing pod for use in fighting a target area of a fire, the pod comprises:
a housing for housing a fire retardant, the housing comprising
a thin-walled outer casing, and
a light weight container which receives and contains the fire retardant,
whereupon detonation of the container the housing disintegrates into small pieces and the fire retardant is released from the pod, the pieces being of a size which will not cause injury should the pieces fall on property or persons.

2. The fire extinguishing pod according to claim 1 wherein the pod incorporates two modes of operation, a saturation mode whereby the fire retardant is rapidly discharged from the pod to a discrete target area and a spreading mode whereby the fire retardant is gradually discharged from the pod as the pod travels over a larger target area.

3. The fire extinguishing pod according to claim 2 wherein in the saturation mode the container is detonated to allow for the rapid discharge of the fire retardant from the pod.

4. The fire extinguishing pod according to claim 2 or 3 wherein in the spreading mode the container is pierced to allow for the gradual discharge of the fire retardant from the pod.

5. The fire extinguishing pod according to any one of claims 1 to 4 wherein the outer casing incorporates an opening system which is movable from a closed position to an open position, wherein in the closed position the outer surface of the casing is relatively smooth, wherein in the open position the casing provides at least one aperture therein.

6. The fire extinguishing pod according to claim 5 wherein when the opening system moves to the open position, the container is pierced allowing the fire retardant to be released from the pod through the at least one aperture.

7. The fire extinguishing pod according to claim 5 or 6 wherein the opening system comprises a plurality of louvres incorporated in the casing, each louvre is associated with an aperture in the casing.

8. The fire extinguishing pod according to any one of the preceding claims wherein the housing disintegrates into small pieces and the fire retardant is released from the pod upon detonation of the container, the pieces being of a size which will not cause damage or injury should the pieces fall on property or persons.

9. The fire extinguishing pod according to any one of the preceding claims comprising a first propulsion apparatus for propelling the pod to the target area.

10. The fire extinguishing pod according to claim 9 wherein the first propulsion apparatus is releasably secured to the housing.

11. The fire extinguishing pod according to claim 10 wherein the propulsion apparatus incorporates a parachute.

12. The fire extinguishing pod according to claim 9, 10 or 11 wherein the first propulsion apparatus incorporates a tracking system.

13. The fire extinguishing pod according to claim 9, 10, 11 or 12 wherein the first propulsion apparatus is in the form of a hybrid rocket.

14. The fire extinguishing pod according to claim 9, 10, 11, 12 or 13 wherein the first propulsion apparatus is operable during flight such that it can be turned on or off.

15. The fire extinguishing pod according to any one of claims 1 to 8 wherein propulsion is provided by an external propulsion system.

16. The fire extinguishing pod according to any one of claims 1 to 15 the container is made from a lightweight non-metallic material.

17. The fire extinguishing pod according to any one of claims 1 to 16 wherein the container incorporates explosive charges therein such that upon detonation the resultant explosion causes the container to disintegrate into small pieces which are sufficiently small to fall harmlessly to the ground.

18. The fire extinguishing pod according to claim 17 wherein the casing incorporates explosive charges therein such that upon detonation the resultant explosion causes the casing to disintegrate into small pieces which are sufficiently small to fall harmlessly to the ground.

19. The fire extinguishing pod according to claim 18 wherein the container and casing explode simultaneously such that the housing disintegrates into small pieces.

20. The fire extinguishing pod according to any one of claims 1 to 16 wherein the container incorporates explosive charges therein such that upon detonation the resultant explosion causes the housing to disintegrate into small pieces which are sufficiently small to fall harmlessly to the ground.

21. The fire extinguishing pod according to any one of claims 1 to 20 wherein the container is reinforced by a series of straps which surround the container in a grid like pattern.

22. The fire extinguishing pod according to claim 21 wherein the straps are made from the same lightweight material from which the container is made.

23. The fire extinguishing pod according to claim 21 or 22 wherein the straps incorporate an explosive material.

24. The fire extinguishing pod according to claim 21 wherein the straps are made from an explosive material.

25. The fire extinguishing pod according to any one of claims 21 to 24 wherein the straps are configured such that upon detonation the resultant explosion causes the container to disintegrate into small pieces which are sufficiently small to fall harmlessly to the ground.

26. The fire extinguishing pod according to any one of claims 21 to 24 wherein the straps are configured such that upon detonation the resultant explosion causes the housing to disintegrate into small pieces which are sufficiently small to fall harmlessly to the ground.

27. The fire extinguishing pod according to any one of claims 1 to 26 further comprising a guidance system to guide the pod to the target area.

28. The fire extinguishing pod according to claim 27 wherein the first propulsion apparatus is operated remotely and/or is operably dependent on the guidance system.

29. The fire extinguishing pod according to claim 27 or 28 wherein the guidance system incorporates a camera which transmits video to the operator.

30. The fire extinguishing pod according to claim 27, 28 or 29 further comprising a steering system which can steer the pod to the target area, the steering system is operated remotely and/or is operably dependent on the guidance system.

31. The fire extinguishing pod according to any one of claims 1 to 30 further comprising gliding apparatus to increase the distance the pod travel.

32. The fire extinguishing pod according to claim 31 wherein the gliding apparatus include fins.

33. The fire extinguishing pod according to claim 32 wherein the fins are extendible from a retractable position to an extended position.

34. The fire extinguishing pod according to claim 32 wherein the fins stabilise the pod during flight.

35. The fire extinguishing pod according to any one of claims 1 to 34 further comprising a second propulsion apparatus, wherein the second propulsion apparatus propels the pod in a substantially vertical direction.

36. The fire extinguishing pod according to any one of claims 27 to 35 wherein the first propulsion apparatus is operated remotely and/or is operably dependent on the guidance system.

37. The fire extinguishing pod according to any one of claims 1 to 36 wherein detonation is remotely activated by an operator, or is automatically activated according to the condition of the pod.

38. A fire extinguishing pod for use in fighting fires, the pod comprises:
a housing for housing a fire retardant, the housing comprising
a thin-walled outer casing, and
a light weight container which receives and contains the fire retardant, the light weight container
wherein the pod incorporates two modes of operation, a saturation mode whereby the fire retardant is rapidly discharged from the pod to a discrete target area and a spreading mode whereby the fire retardant is gradually discharged from the pod as the pod travels over a larger target area.

39. A fire extinguishing pod for use in fighting fires, the pod comprises:
a housing for housing a fire retardant, the housing comprising
a thin-walled outer casing, and
a light weight container which receives and contains the fire retardant,
whereupon detonation of the container the fire retardant is released from the pod

40. A fire extinguishing pod for use in fighting fires, the pod comprises:
a housing for housing a fire retardant, the housing comprising
a thin-walled outer casing, the thin walled outer casing incorporating an opening system which is movable from a closed position to an open position, and
a light weight container which receives and contains the fire retardant,
whereupon the opening system moving to the open position, the container is pierced allowing the fire retardant to be released from the pod.

41. The fire extinguishing pod according to claim 40 wherein the opening system comprises a plurality of louvres/vents incorporated in the casing.

42. The fire extinguishing pod according to claim 40 or 41 wherein the opening system is controlled to open the louvres/vents to the open position or to a partially opened positioned.

43. A fire extinguishing pod for use in fighting fires, the pod being adapted to travel through atmosphere to a target area, the pod comprises:
a housing for housing a fire retardant, the housing comprising
a thin-walled outer casing, and
a light weight container which receives and contains the fire retardant,
whereupon detonation of the container the fire retardant is released from the pod.
